(19) United States
(12) Patent Application Publication
(10) Pub. No.: US 2011/0075142 A1
(43) Pub. Date: Mar. 31, 2011

(54) OPTICAL DETECTION SYSTEM

(75) Inventors: Sandip Maity, Bangalore (IN); Ayan Banerjee, Bangalore (IN); Shankar Chandrasekaran, Bangalore (IN); Anis Zribi, Colorado Springs, CO (US); Shivappa Ningappa Goravar, Bangalore (IN); David Cecil Hays, Gainesville, FL (US); Dirk Lange, Munchen (DE); Renato Guida, Wynantskill, NY (US)

(73) Assignee: GENERAL ELECTRIC COMPANY, SCHENECTADY, NY (US)

(21) Appl. No.: 12/566,809

(22) Filed: Sep. 25, 2009

(51) Int. Cl. G01J 3/28; G01N 21/25; G02B 6/10; G02B 27/00

(52) U.S. Cl. 356/326; 250/227.23; 356/301

(57) ABSTRACT

Optical detection systems and optical spectrometric systems are presented. One embodiment is a parallelized optical detection system. The detection system includes collector optics configured to receive an input optical signal, a plurality of optical filters and a plurality of tunable cavities. The collector optics includes at least one collector lens and at least one fiber multiplexer. The plurality of optical filters are configured to receive the input optical signal from the fiber multiplexer, and have serially varying pass band configured to filter the input optical signal at respective bandwidths. Each of the plurality of tunable cavities is optically coupled to each filter of the respective plurality of optical filters to receive a respective filtered output signal. The plurality of tunable cavities have band-pass frequencies with center frequencies staggered. At least one fiber demultiplexer is configured to receive respective filtered signals from the plurality of tunable cavities, and at least one detector is configured to receive and detect an output optical signal from the demultiplexer.

### BACKGROUND

The invention relates generally to optical detection systems. The invention more particularly relates to optical spectrometric systems.

Hand-held micro-spectrometers based on MEMS technology have wide applications in chemical and biological detection and monitoring. Fabry-Perot (FP) etalon based systems have been used to separate out the Raman peaks individually in order to obtain the Raman frequency spectrum of an analyzed sample. However, to achieve a high resolution of less than 5 cm⁻¹ as well as a tuning range of ˜180 nm using a single FP cavity, it is essential that the etalon has a very large finesse. For a cavity with plane mirrors, the finesse (and thus the throughput) is largely limited by the reflectance of the mirrors, the parallelism between them, their surface flatness and roughness. To achieve finesses in excess of 100 requires reflectance greater than 97% and mirror parallelism, roughness and flatness of the order of a few nanometers. Achieving these levels of control is a challenge, especially for vertically etched Si mirrors.

The finesse achieved by most MEMS spectrometers based on linear FP cavities is typically not more than 60, which leads to limited resolution. Most MEMS spectrometers also have tunability less than 100 nm.

Therefore there is a need for a microspectrometer that can provide both high resolution and high tunability.

### BRIEF DESCRIPTION

In one embodiment, a parallelized optical detection system is disclosed. The detection system includes collector optics configured to receive an input optical signal, wherein the collector optics comprises at least one collector lens and at least one fiber multiplexer, a plurality of optical filters, wherein the plurality of optical filters are configured to receive the input optical signal from the fiber multiplexer, and wherein the plurality of optical filters have serially varying pass band configured to filter the input optical signal at respective bandwidths, a plurality of tunable cavities, wherein each of the plurality of tunable cavities is optically coupled to each filter of the respective plurality of optical filters to receive a respective filtered output signal, wherein the plurality of tunable cavities have band-pass frequencies with center frequencies staggered, at least one fiber demultiplexer configured to receive respective filtered signals signal from the plurality of tunable cavities, and at least one detector configured to receive and detect an output optical signal from the demultiplexer.

In one embodiment, a parallelized optical detection system is disclosed. The detection system includes collector optics configured to receive an input optical signal, wherein the collector optics comprises at least one collector lens and at least one fiber multiplexer, a tunable monochromator, wherein the tunable monochromator is configured to receive a multiplexer output signal from the fiber multiplexer, to filter the multiplexer output signal at serially varying pass bands, a plurality of tunable cavities, wherein each of the plurality of tunable cavities is optically coupled to the tunable monochromator to receive a respective filtered signal from the monochromator, wherein the plurality of tunable cavities have band-pass frequencies with center frequencies staggered, at least one fiber demultiplexer configured to receive respective filtered signals signal from the plurality of tunable cavities, and at least one detector configured to receive and detect an output optical signal from the demultiplexer.

Another embodiment is a MEMS (Micro-Electro-Mechanical Systems) spectrometer system including a chamber to house a sample, a light source, wherein a light output from the light source optically excites the sample in the chamber, collector optics configured to receive an excitation signal from the sample, wherein the collector optics comprises at least one collector lens and at least one fiber multiplexer; a plurality of optical filters, wherein the plurality of optical filters are configured to receive the input optical signal from the fiber multiplexer, wherein the plurality of optical filters have serially varying bandwidths configured to filter the input signal at respective bandwidths; a plurality of tunable cavities, wherein each of the plurality of tunable cavities is optically coupled to each filter of the respective plurality of optical filters to receive a respective filtered output, wherein the plurality of tunable cavities have band-pass frequencies with center frequencies staggered for each tunable cavity; at least one fiber demultiplexer configured to receive signal output; and at least one detector configured to receive and detect an output signal from the demultiplexer.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic representation of a prior art infrared spectrometer system.

FIG. 2A is a schematic representation of a tunable cavity in one embodiment of the present invention.

FIG. 2B is a schematic representation of a tunable cavity in one embodiment of the present invention.

FIG. 3 is a schematic representation of an infrared spectrometer system in one embodiment of the present invention.

FIG. 4 is a schematic representation of an infrared spectrometer system in another embodiment of the present invention.

### DETAILED DESCRIPTION

Embodiments of the present invention disclose parallelized optical detection using multiple tunable etalons. The system provides high tuning range and resolution for frequency filtering the output signal of optical systems such as Infrared and Raman microspectrometers.

In the following specification and the claims that follow, the singular forms “a”, “an” and “the” include plural referents unless the context clearly dictates otherwise.

As used herein “serially varying bandwidths” refers to a plurality of filters whose bandwidths vary in sequence, with serially or marginally overlapping bandwidths.

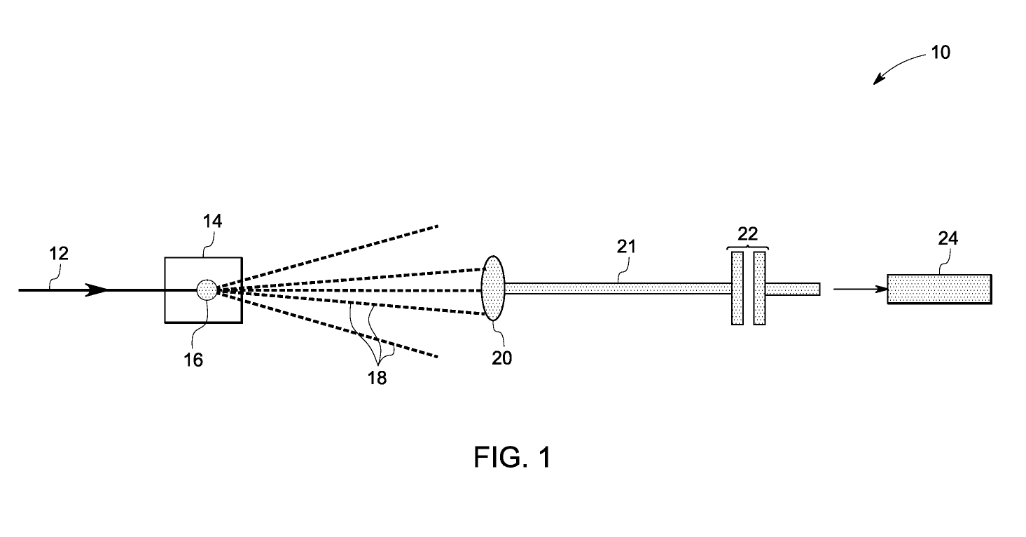

FIG. 1 is a schematic representation of a prior art infrared spectrometer system 10. A laser beam 12 excites a sample volume 16 housed in a chamber 14. In one example, the sample is a gaseous sample. The beam 12 is partly absorbed, partly scattered and partly transmitted through the sample volume 16 contained in the chamber 14. The emitted light 18 is collected by lens 20 and coupled into a spectrometer 22 through a fiber 21 and is subsequently incident on a detector 24. As discussed earlier, systems such as shown in FIG. 1 have limited resolution and tunability.

In contrast to currently known detection schemes such shown in FIG. 1, embodiments of the present invention employ a parallelized detection scheme using a plurality of tunable cavities, wherein each of the plurality of tunable cavities, sample a portion of an optical spectrum. By using a parallelized detection scheme as described herein, it is possible to obtain the desired tunability and resolution. In one example, the optical signal is a Raman or IR emission signal.

An optical signal to be analyzed may be collected using multiple optical fibers, which are integrated with the plurality of tunable cavities. Each tunable cavity may be coupled to a band-pass filter in front of it so that only a portion of the optical signal is introduced into each tunable cavity. In one embodiment, each filter has a pre-determined bandpass (of width=cavity tuning range) that is non-overlapping with the other filters.

In one embodiment, the tunable cavity is an etalon. In one embodiment, the optical detection system is implemented using Fiber Bragg Gratings (FBG) having high throughput. The Fiber Bragg Gratings are present in a single mode fiber. Other non-limiting examples of filters include photonic band-gap based, liquid-core waveguides, or a liquid crystal tunable filter that transmits only a particular band of wavelength. For liquid-core waveguides, fluids with different refractive index may be used for the different filters. In some embodiments the filters such as FBGs may be modulated to reflect or transmit at the desired frequencies.

In a further embodiment, the optical detection system is implemented using single mode optical fiber with FBGs' of different pitch (and therefore different reflection wavelength). The output of each FBG is connected to a tunable cavity individually. The pitch of each grating is such that it reflects only the required band of wavelength (equal to the cavity tuning range) and transmits the rest. This would lessen signal losses due to fiber-multiplexing. In one embodiment, the bandwidth of each filter is in a range from about 30 nanometers to about 40 nanometers. Furthermore, a combined bandwidth of the plurality of filters is in a wavelength range of from visible to infrared, in one embodiment.

The band-pass frequencies are so designed that the center frequencies are staggered for each tunable cavity. The tunable cavities are tunable over a wavelength range of from about 30 nanometers to about 60 nanometers. The tunable cavities may be scanned in parallel or in each series, so that each resolves a portion of the optical signal. The cavities may be tuned in sync using a common voltage source, or in series. The signal from each tunable cavity may then be collected by an individual detect or and the total signal from all detectors put together to build up a complete optical signal. Alternately, a single detector may be used to receive the signal from each tunable cavity, one at a time. Signal processing can then be used to build the optical spectrum.

In one embodiment, the tunable cavities are Fabry-Perot cavities. The cavity is defined by a pair of micro mirrors, which both can be flat, curved, or one flat and one curved. One of the two minors is static while the second minor is movable and attached to an actuator. The actuator may be thermal, electrostatic or magnetic in nature. When broadband light is coupled to the cavity, multiple internal reflections and refractions occur and interference between transmitted beams takes place. The wavelength of the transmitted light is a function of the distance between the cavity mirrors, which is also known as cavity length. At specific cavity lengths, interference is constructive.

Micro optical components such as optical fibers are integrated with the Fabry-Perot cavity using microchannels, grooves, springs or other fixturing mechanisms. The cavity minor may be an optical fiber minor and/or a MEMS minor. Manufacture of MEMS minors is relatively well known, and the minors may be fabricated using, for example, bulk micromachining with silicon wafers or silicon on insulator (SOI) wafers. The structure may be formed by etching surfaces of the wafer with one or more masking steps. Optical fiber minor is etched out of single mode fiber polished on one side. The cavity mirrors may have metalized coating to increase reflectivity.

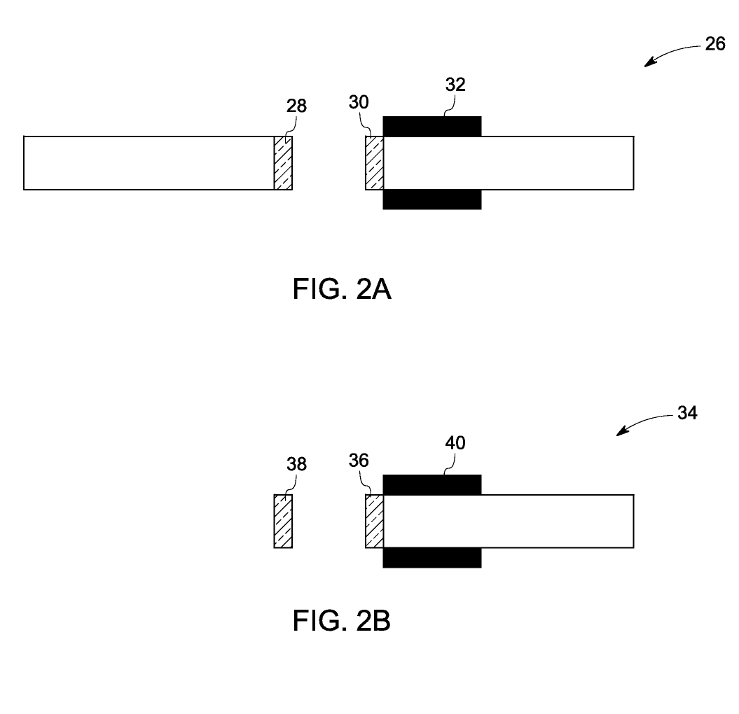

In a non-limiting example, the ends of two single mode fibers may be polished to form the cavity minors. FIG. 2A illustrates a tunable cavity 26 having two optical fiber minors 28 and 30, the optical fiber minor 30 being movable. An actuator 32 is in contact with the optical fiber minor 30. In an alternate example, the cavity minors are a pair of silicon MEMS minors.

In some embodiments, the tunable cavity is a hybrid MEMS Fabry-Perot cavity 34 as shown in FIG. 2B. The hybrid cavity 34 has an optical fiber minor 36 and a MEMS minor 38. The optical fiber minor 36 is movable. The hybrid cavity aligns the optical fiber in order to get highest parallelism. The hybrid MEMS FP cavity 34 includes a comb actuator 40 driving the movable optical fiber minor 36.

In various embodiments of the present invention, detection may be carried out using multiple detectors or with a single detector, which would be switched between different cavities. For a single detector, alternatively, one can modulate the signal entering each cavity at a different frequency and then demodulate the output of the cavity at the detector at that particular frequency. Alternatively, modulation of the cavity length at different frequencies, which may subsequently then be demodulated at the detector, is also a possibility. In one embodiment, the detector is a spectrometer.

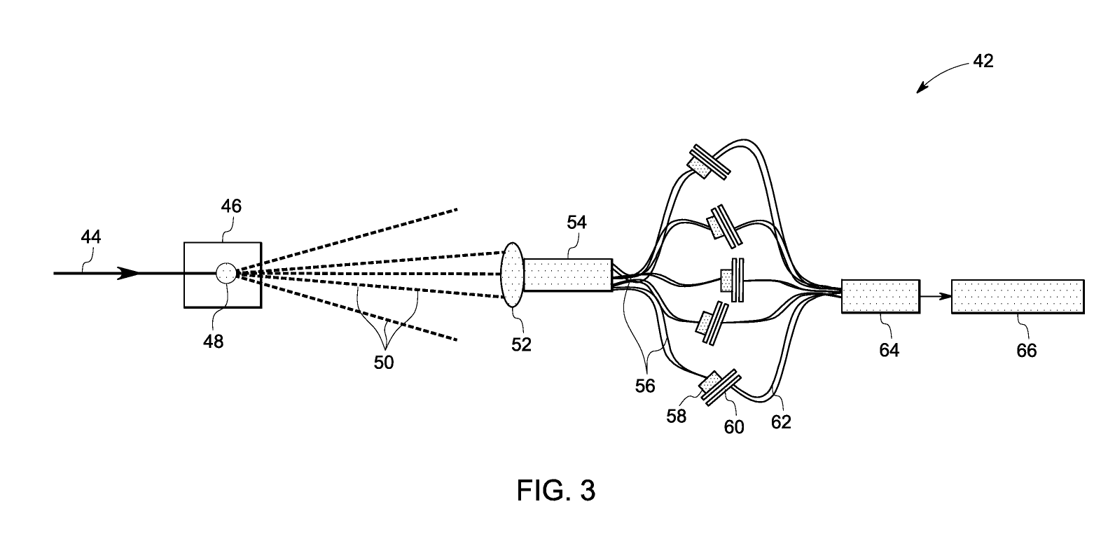

FIG. 3 is a schematic representation of an infrared spectrometer system 42, in one embodiment of the present invention. Excitation light 44 from a light source is incident on a chamber 46 and excites sample molecules 48. The emission or scattering (50) from the excited samples is collected by collector optics including lens 52 and a fiber multiplexer 54. The lens couples the collected emission light into the fiber multiplexer 54. In one embodiment, wherein for example, an input signal is Raman scattered light, the scattered light is collected using a fiber multiplexer with a single core collecting the light initially and then branching the light off into a plurality of n cores.

The multiplexer output signal is then coupled into fibers 56 and are subsequently coupled into optical filters 58 and the respective tunable cavities 60. The optical filters 58 have serially varying pass band. For example, the center pass wavelength of each optical filter is staggered, i.e. the first one may have that of 1018 nm, the next one 1054 nm, and so on. In some embodiments, a tunable monochromator is configured to receive the multiplexer output signal from the fiber multiplexer. The tunable monochromator filters the multiplexer output signal at serially varying pass band. The output of the tunable cavities 60 are coupled into output fibers 62 and then coupled into a demultiplexer 64, wherein multiple fiber cores lead on to a single core. The output from the demultiplexer is finally incident on a detector 66. In one embodiment, a switching mechanism is used so that the detector receives the output from only one cavity at a time.

A variety of detectors can be used to receive the output from the demultiplexer. Non-limiting examples of such detectors include a photodetector, a photomultiplier tube, a micro-channel plate detector (MCP), and a scintillator. In one example, the photodetector is an avalanche photodetector (APD).

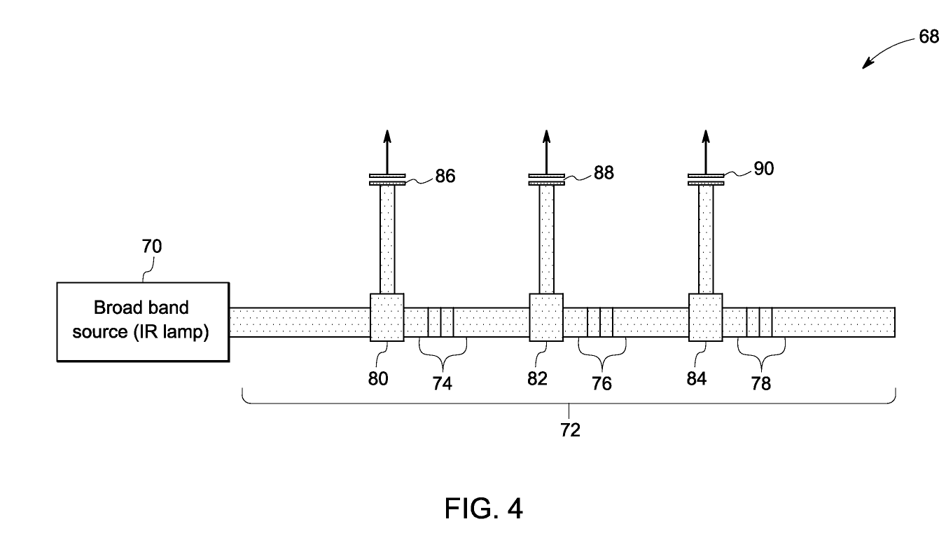

FIG. 4 is a schematic representation of an infrared spectrometer system 68. The output of a broadband source 70 is coupled into a single fiber 72 with integrated Bragg gratings 74, 76, and 78. Using circulators 80, 82, 84, the light reflected by the gratings 74, 76, and 78 are transmitted through to tunable cavities 86, 88, 90 respectively and subsequently detected.

In one example, an optical detection system such as illustrated in FIG. 3 comprises three tunable cavities of length 8.3 micrometers, each with a tuning range of 60 nm. Light from a broadband source is coupled into a multimode fiber with 3 FBGs' written on it. Each cavity is integrated with a fiber circulator connected to individual FBG outputs (which transmits the wavelength band reflected from the FBG). Given 3 FBGs' with different wavelength reflection bands, for example from 1000-1060, 1060-1120, and 1120-1180 nm, coupled individually into the different cavities, it will be seen from the output of each cavity that all wavelengths other than those reflected by the FBGs' are absent in the output signal.

In some embodiments, the optical detection system is a MEMS Fabry Perot Spectrometer, which can be used to frequency calibrate the Raman signal of the samples obtained by the complete Raman Micro-system.

In embodiments of the present invention, to obtain a tunability of ˜180 nm and resolution ˜5 cm-1, several configurations are possible. A few representative examples are shown in Table 1.

TABLE 1
Optical detection system configurations

| | Cavity | | | Paral- | | |
|---|---|---|---|---|---|---|
| | length | Total | Reflec- | lelism | Roughness | Flatness |
| No of | required | finesse | tance | required | required | required |
| cavities | (μm) | required | required | (mdeg) | (nm) | (nm) |
| 1 | 2.78 | 359.5 | 0.995 | 0.21 | 0.38 | 0.5 |
| 2 | 5.56 | 179.8 | 0.99 | 0.54 | 0.67 | 1 |
| 5 | 13.9 | 72 | 0.985 | 2.0 | 1.67 | 2.5 |
| 10 | 27.8 | 36 | 0.985 | 5 | 2.9 | 4 |
| 15 | 41.6 | 24 | 0.982 | 6.7 | 5 | 7.5 |

As is evident from Table 1, with an increase in the number of cavities, the less stringent are the cavity parameter requirements for obtaining the desired tunability and resolution. For example, to have tunability of 180 nm and a resolution of 5 cm-1, for a start wavelength of 1000 nm, the required reflectance is ˜99.5, surface roughness is ˜0.4 nm, flatness is ˜0.5 nm, and tilt angle is ˜0.2 mdeg (assuming a mirror size of 150×150 um), for a cavity length of 2.695 um. Most currently available plane-mirror based Fabry Perot devices have finesse between 30-60. For example, to scan from 1000-1180 nm, an optical detection system using 5 cavities, each scanning 36 nm, with a different start wavelength, i.e. 1000-1036 nm, 1036-1072 nm, 1072-1108 nm, 1108-1144 nm, and 1144-1180 nm can be implemented

Such a system with 5 cavities with staggered band-pass frequencies, for example, would have a flatness of 2.5 nm and a roughness of 1.67 are required as compared to the desired flatness (0.5 nm) and roughness (0.38 nm) levels for a system with a single cavity, as can be seen from Table 1.

Therefore, advantageously, embodiments of the present invention enable relaxed process tolerances towards obtaining ultra-high reflectance, parallelism, smoothness and flatness of MEMS mirrors for the tunable cavities.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A parallelized optical detection system comprising:
collector optics configured to receive an input optical signal, wherein the collector optics comprises at least one collector lens and at least one fiber multiplexer;
a plurality of optical filters, wherein the plurality of optical filters are configured to receive a multiplexer output signal from the fiber multiplexer, wherein the plurality of optical filters have serially varying pass band configured to filter the multiplexer output signal at respective pass bands;
a plurality of tunable cavities, wherein each of the plurality of tunable cavities is optically coupled to each filter of the respective plurality of optical filters to receive a respective filtered signal from the optical filters, wherein the plurality of tunable cavities have band-pass frequencies with center frequencies staggered;
at least one fiber demultiplexer configured to receive tunable cavity output signals from the plurality of tunable cavities; and
at least one detector configured to receive and detect a demultiplexer output signal from the demultiplexer.

2. The optical detection system of claim 1, further comprising a plurality of input fibers configured to couple the multiplexer output signal out of the at least one fiber multiplexer into the plurality of filters.

3. The optical detection system of claim 1, comprising a plurality of output fibers coupled to transport the respective tunable cavity output signals from the plurality of filters to the at least one fiber demultiplexer.

4. The optical detection system of claim 1, wherein the plurality of optical filters comprise band pass filters.

5. The optical detection system of claim 1, wherein the plurality of optical filters comprise fiber Bragg gratings.

6. The optical detection system of claim 5, wherein the fiber Bragg gratings are present in a single mode fiber.

7. The optical detection system of claim 1, wherein the plurality of optical filters comprise photonic band gap waveguides.

8. The optical detection system of claim 1, wherein the optical filter comprises a liquid-core waveguide.

9. The optical detection system of claim 1, wherein the optical filter comprises a liquid crystal tunable filter.

10. The optical detection system of claim 1, wherein the plurality of tunable cavities comprises a Fabry Perot cavity.

11. The optical detection system of claim 1, wherein the plurality of tunable cavities comprises a pair of optical fiber mirrors, a pair of MEMS mirrors or a combination of an optical fiber minor and a MEMS minor.

12. The optical detection system of claim 1, wherein the respective bandwidth of each filter of the plurality of filters is in a range from about 30 to 40 nanometers.

13. The optical detection system of claim 1, wherein a combined bandwidth of the plurality of filters is in a wavelength range from visible to infrared.

14. The optical detection system of claim 1, wherein each of the plurality of tunable cavities is tunable over a wavelength range of 30 to 60 nanometers.

15. The optical detection system of claim 1, further comprising a plurality of fiber circulators.

16. The optical detection system of claim 1, further comprising a switching mechanism to enable the at least one detector to selectively receive the tunable cavity signals from the one or more tunable cavity of the plurality of tunable cavities.

17. The optical detection system of claim 1, wherein the detector comprises a photodetector, a photomultiplier tube, a micro-channel plate detector (MCP), or a scintillator.

18. A parallelized optical detection system comprising:
collector optics configured to receive an input optical signal, wherein the collector optics comprises at least one collector lens and at least one fiber multiplexer;
a tunable monochromator, wherein the tunable monochromator is configured to receive a multiplexer output signal from the fiber multiplexer, to filter the multiplexer output signal at serially varying pass bands;
a plurality of tunable cavities, wherein each of the plurality of tunable cavities is optically coupled to the tunable monochromator to receive a respective filtered signal from the monochromator, wherein the plurality of tunable cavities have band-pass frequencies with center frequencies staggered;
at least one fiber demultiplexer configured to receive tunable cavity output signals from the plurality of tunable cavities; and
at least one detector configured to receive and detect a demultiplexer output signal from the demultiplexer.

19. A MEMS spectrometer system comprising:
a chamber to house a sample; and
a light source, wherein a light output from the light source optically excites the sample in the chamber;
collector optics configured to receive an excitation signal from the sample, wherein the collector optics comprises at least one collector lens and at least one fiber multiplexer;
a plurality of optical filters, wherein the plurality of optical filters are configured to receive a multiplexer output signal from the fiber multiplexer, wherein the plurality of optical filters have serially varying pass band configured to filter the multiplexer output signal at respective pass bands;
a plurality of tunable cavities, wherein each of the plurality of tunable cavities is optically coupled to each filter of the respective plurality of optical filters to receive a respective filtered signal from the optical filters, wherein the plurality of tunable cavities have band-pass frequencies with center frequencies staggered;
at least one fiber demultiplexer configured to receive tunable cavity output signals from the plurality of tunable cavities; and
at least one detector configured to receive and detect a demultiplexer output signal from the demultiplexer.
